(19) United States
(12) Patent Application Publication
(10) Pub. No.: US 2011/0255276 A1
(43) Pub. Date: Oct. 20, 2011

(54) LIGHTING ASSEMBLY

(76) Inventor: Mark T. Coward, Wheaton, IL (US)

(21) Appl. No.: 13/088,066

(22) Filed: Apr. 15, 2011

Related U.S. Application Data
(60) Provisional application No. 61/325,447, filed on Apr. 19, 2010.

(51) Int. Cl. F21V 1/00

(52) U.S. Cl. 362/217.02

(57) ABSTRACT

A light assembly including a multi-faceted, LED light array. The LED light array consists of a light support, which is provided with a center strip segment, a first outer inclined segment, and a second outer inclined segment. Each of these three segments supports a strip, or row of LEDs. The LEDs are arranged in a linear row so that the light from each of the rows are in the same horizontal plane. Power wires are connected to each strip at one or more ends of the assembly to supply electrical power to the LEDs for illumination. The two outer strip segments are each arranged to be angled toward the center strip segment. Together the three segments create an LED Lamp Array.

The present application claims priority to U.S. Provisional Patent Application Ser. No. 61/325,447 filed on Apr. 19, 2010, which is herein incorporated by reference.

### BACKGROUND

The present disclosure relates to lighting and in particular to electric lighting. More particularly, the present disclosure relates to electric lighting that uses Light Emitting Diodes (LEDs) to generate light. LED lights produce intense light beams that do not provide evenly diffused light when grouped together, creating light hot spots that are noticeable to the user of the product. The light produced is not evenly disbursed, such as the light produced from a fluorescent bulb, for example.

### SUMMARY

According to the present disclosure, a lighting assembly is adapted to use a plurality of LEDs to form a light source. The lighting assembly is configured to provide evenly disbursed lighting to provide uniform illumination.

In illustrative embodiments, the lighting assembly includes a multi-faceted, LED light array. The LED light array consists of a support, which includes a center strip segment, a first outer inclined segment, and a second outer inclined segment. Each of these three segments supports a strip, or row of LEDs. The LEDs are arranged in a linear row so that the light from each of the rows are in the same horizontal plane. Power wires are connected to each strip at one or more ends of the assembly to supply electrical power to the LEDs for illumination. The two outer strip segments are each arranged to be angled toward the center strip segment. Together the three segments create an LED Lamp Array.

This invention gives improved diffusion of light from a multi-LED lamp, by placement of the LEDs in an angled row formation, so that the light projected from the outer LED beams crosses the width of the lamp housing before striking the diffuser. The light beams are emitted from the LEDs in a cone of light energy. Increasing the distance of the LEDs from the diffuser allows the area of light to be wider at the lamp's diffuser than would be achieved if the LED beams were simply directed at the closest surface of the diffuser

Additional features of the disclosure will become apparent to those skilled in the art upon consideration of the following detailed description of illustrative embodiments exemplifying the best mode of carrying out the disclosure as presently perceived.

### BRIEF DESCRIPTION OF THE DRAWINGS

The detailed description particularly refers to the accompanying figures in which:

FIG. 1 is a perspective view of a light support of the present disclosure showing a series of LEDs positioned along its length on the center and inclined strip segments;

FIG. 2 is a side elevational view of the lighting assembly showing the housing, the light support and the diffuser;

FIG. 3 is a top view of an example of a multiple LED strip arrangement;

FIG. 4 is series of side elevational views showing the light beams being emitted by the various LEDs;

FIG. 5 illustrates the light output with the light support removed;

FIG. 6 illustrates an embodiment of the light support wherein the inclined strip segments are pivotally coupled to the center strip segment;

FIG. 7 is a side elevational view of the light support of FIG. 6;

FIG. 8 illustrates the light beam pattern of three LED all positioned on the same plane;

FIG. 9 illustrates the light beam pattern of three LEDs mounted on the light support;

FIG. 10 illustrates the light beam pattern of three LEDs with one LED mounted on a plane different than the first two LEDs; and

FIG. 11 illustrates the light beam pattern of three LEDs mounted on different planes.

### DETAILED DESCRIPTION

While the present disclosure may be susceptible to embodiment in different forms, there are shown in the drawings, and herein will be described in detail, embodiments with the understanding that the present description is to be considered an exemplification of the principles of the disclosure and is not intended to limit the disclosure to the details of construction and the arrangements of components set forth in the following description or illustrated in the drawings.

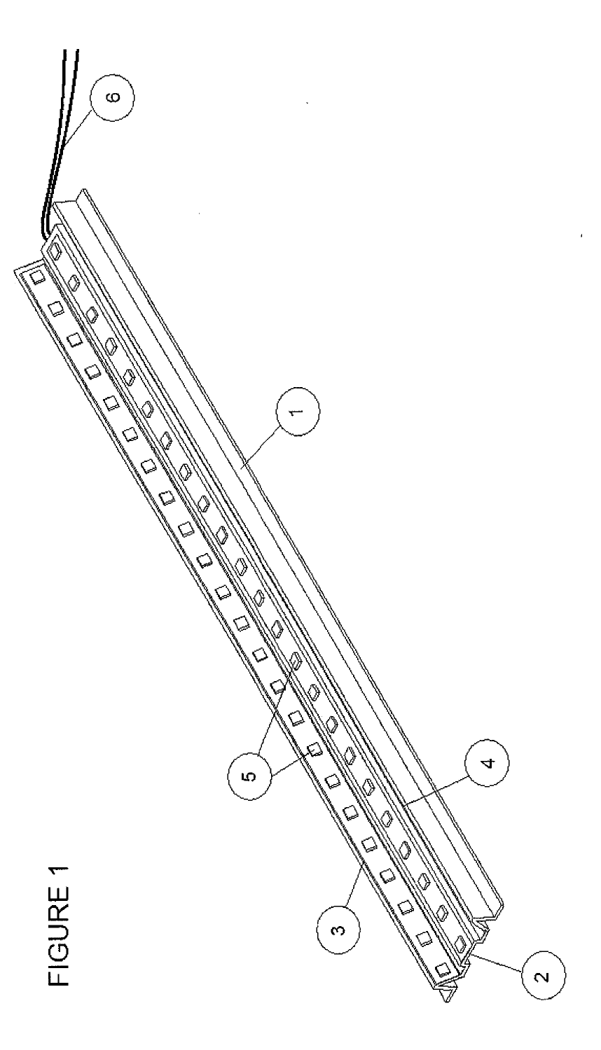

The present disclosure relates to a multi-faceted, Light Emitting Diode (LED) light array as shown in FIG. 1. The LED Light Array consists of a support 1, which includes a center strip segment 2, a first outer inclined segment 3, and a second outer inclined segment 4. Each of these three segments supports a strip, or row of LEDs 5, the LEDs are arranged in a linear row so that the light from each of the rows 2, 3 & 4 are in the same horizontal plane. Power wires 6, are connected to each strip at one or more ends of the assembly to supply electrical power to the LEDs for illumination.

The two outer strip segments 3, 4 are each arranged to be angled toward the center strip segment 2. The angle of inclination can be from about zero degrees to about 90 degrees but the angle of preferred range is from about 30 degrees to about 60 degrees. Together the three segments create an LED Lamp Array.

This lighting assembly gives improved diffusion of light from a multi-LED lamp, by placement of the LEDs in an angled row formation, so that the light projected from the outer LED beams crosses the width of the lamp housing before striking the diffuser. The light beams are emitted from the LEDs in a cone of light energy. Increasing the distance of the LEDs from the diffuser allows the area of light to be wider at the diffuser than would be achieved if the LED beams were simply directed at the closest surface of the diffuser.

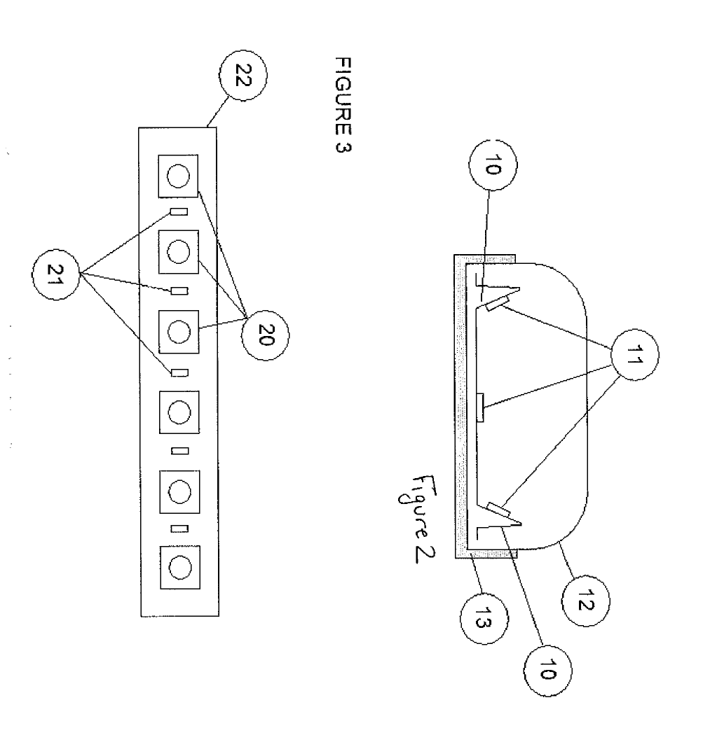

Referring to FIG. 2, a multi-faceted set of forms or segments, which may be comprised of printed circuit boards or extruded, shaped or molded mounting surfaces, with the outer form surfaces, or segments 10, angled so that the light output from a strip or group of LEDs, 11, on the surfaces of the segments will be directed toward a diffuser lens 12. The angles of the LED segments are arranged so as to provide the optimum light to be directed across the width of the housing or enclosure 13, and onto the surface of the diffuser lens 12.

The LEDs on the individual segments may also be arranged offset or staggered to each other between adjacent rows or segments so as to give additional dispersion and diffusion of their individual light output beams. The material from which the form is created may be of a flexible or rigid design and also may be aluminum or other heat conducting material for greater heat dissipation. The diffuser 12, may be optically clear, frosted, and/or, be made of a material containing very fine diffusion particles, such as micro beads. The diffuser may also have a finely ribbed surface or surfaces allowing light passing through it to diffuse or scatter.

Referring to FIG. 3, LEDs are electrically connected in series in groups of two or three or more LEDs 20, along with resistors 21, so that the current through each is appropriate at the applied voltage. In addition pre-assembled strips 22, or sets, of series connected LEDs are also connected in parallel with each other to achieve the required count for the appropriate lamp intensity. In the preferred embodiment, a flexible circuit strip of LEDs with self-adhesive backing surface is adhered to each of the segment surfaces.

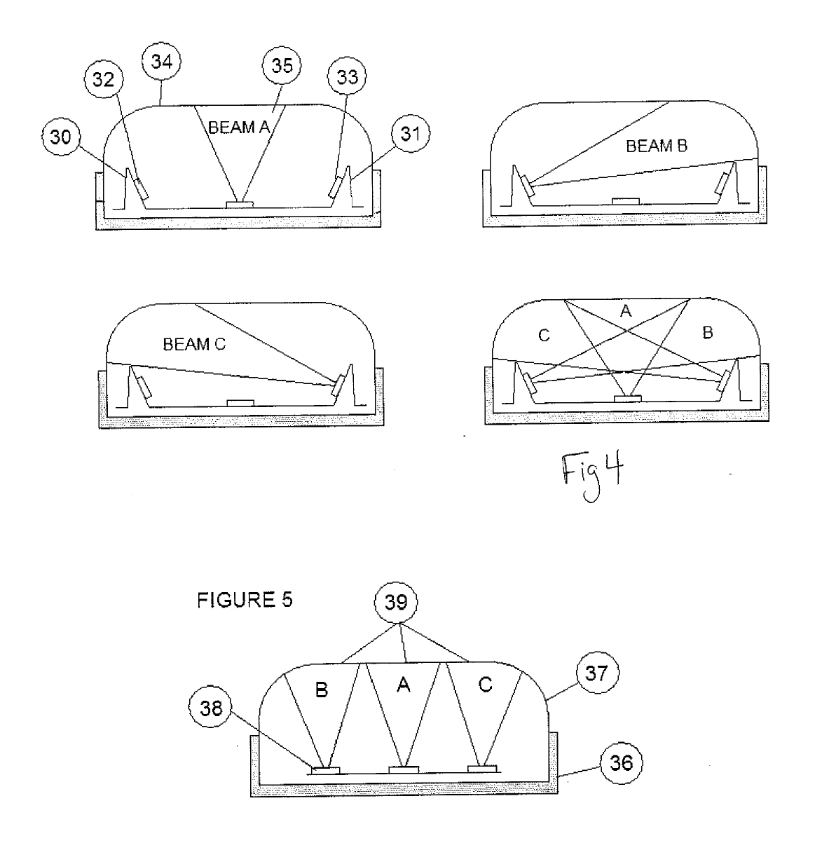

All LEDs have an angle of light dispersion. The light output of the LEDs forms a cone shape, increasing in area to the square of the distance from the LED. Referring to FIG. 4, by using angled LED light support surfaces 30 & 31, and positioning the LEDs 32 & 33, on the inner surface as shown, the outer LEDs 32 & 33, are positioned at a greater distance from the diffuser 34, than if they were positioned near the center of the housing or flat against the rear of the housing. The extra distance provided allows the light emitted by the LEDs to disperse 35, and cover a greater area of the diffusing surface 34, with a proportional reduction in hot spots or uneven points or patches of light.

FIG. 5 represents a cross section of a lamp with the LEDs mounted on a single flat surface in a lamp housing 37, results in a group of individual light patterns 39. The light from each LED 38, is not able to disperse over the short distance from the LED to the diffuser 37, resulting visually in a group of bright light spots (hot spots). Also, areas of the diffuser lens do not receive any direct light from the LEDs. This results in uneven diffusion of the light from the lamp.

An LED which has a dispersion angle of, for example 100 degrees, can be arranged to overlap adjacent LED light beams in the lamp, in such a way as to allow the diffuser to be uniformly struck by incident light over its surface. This allows for a consistent, diffuser surface brightness, instead of hot spots of illumination.

The complete LED light support is assembled into a lamp housing. Alternatively, the base of the housing including the multi-faceted LED strip segments can be made from one single piece of extruded or molded material. The size of the assembly can be scaled dimensionally, so as to fit a wide range of housing sizes and applications, from, for example; small dome lamps in vehicles to very large industrial lamp panels. The lamp housing is elongated and includes strip segments that extend along the length of the lamp housing to create a light field over the entire length of the housing.

FIG. 6 shows another embodiment of the invention using a multi-strip LED assembly, but with one or more of the inclined strip segments hinged relative to the center strip segment. The hinges 40, allow the angle of the outer strip segments 41 & 42, to be able to be changed relative to the center strip segment 43. Many hinge methods are available to perform this function, such as a living hinge, a piano hinge, etc. Extension Ears on the outer strip segments 44, 45, may be provided with a means to guide the strip segments and also to lock them in required positions, so as to set the LED light patterns. By adjusting the angles of the outer strip segments relative to the center segment the light from the outer LED strips are able to be directed at the diffusers of a wide range of different lamp designs allowing the assembly to accommodate various dimensions and shapes of lamps and optimize the diffusion characteristics of each lamp.

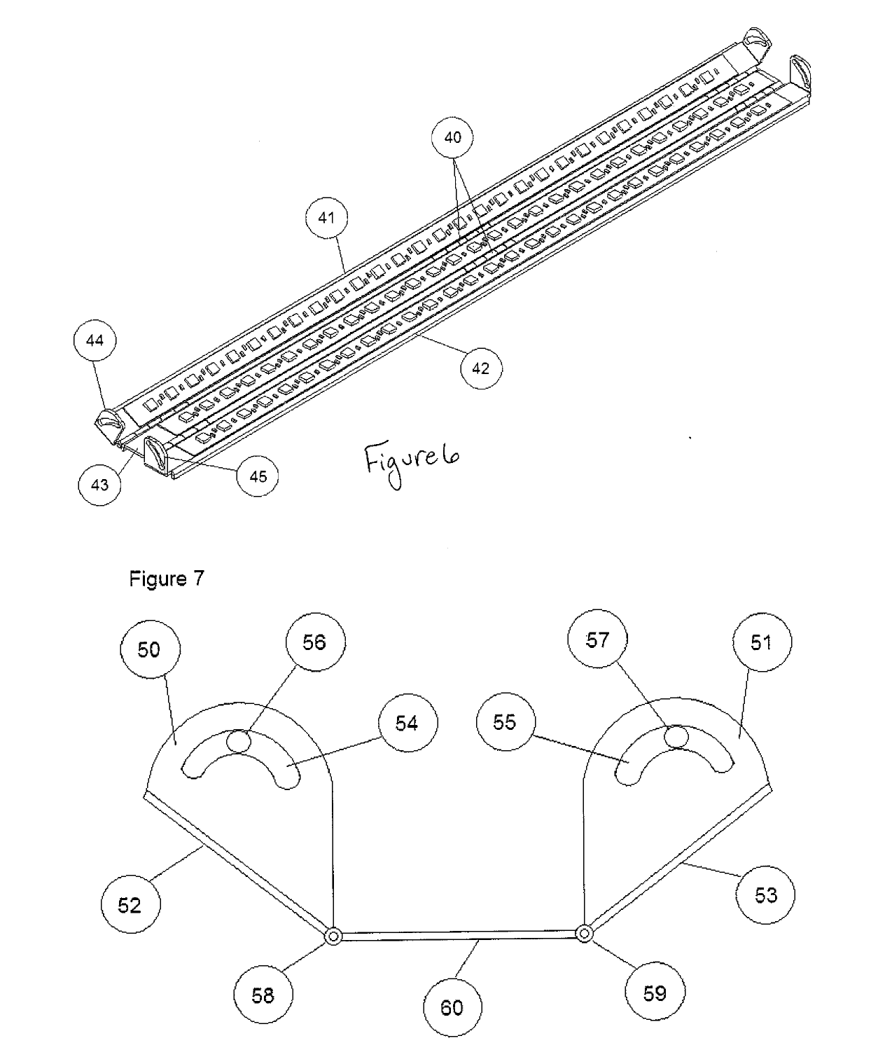

An end view of the LED light support using a typical hinging and extension ear arrangement, is shown in FIG. 7. This arrangement uses extensions tabs or ears 50 & 51, affixed to the ends of each of the outer segments 52 & 53. Each extension ear has an arcuate slot 54 & 55 which engages a fixed pin 56, 57 fixed to the lamp housing. Hinges 38 & 39 join the outer segments 52, 53 to the inner segment 60. The fixed pins 56, 57 act as guides to allow the outer strip segments 52, 53 to be individually moved through a pre-set angle range relative to the fixed center segment 60.

A wide range of methods can be employed to allow for the angle of the outer strips relative to the inner strip to be adjusted and then locked in position, these include, but are not limited to, cams, ratchets, acme or worm drive threads etc. This embodiment enables the hinged rows of LEDs light beams to be adjusted over a range of angles relative to the diffuser, in order to optimize the light pattern at the diffuser. This allows for light optimization in a great variation of housing designs and dimensions.

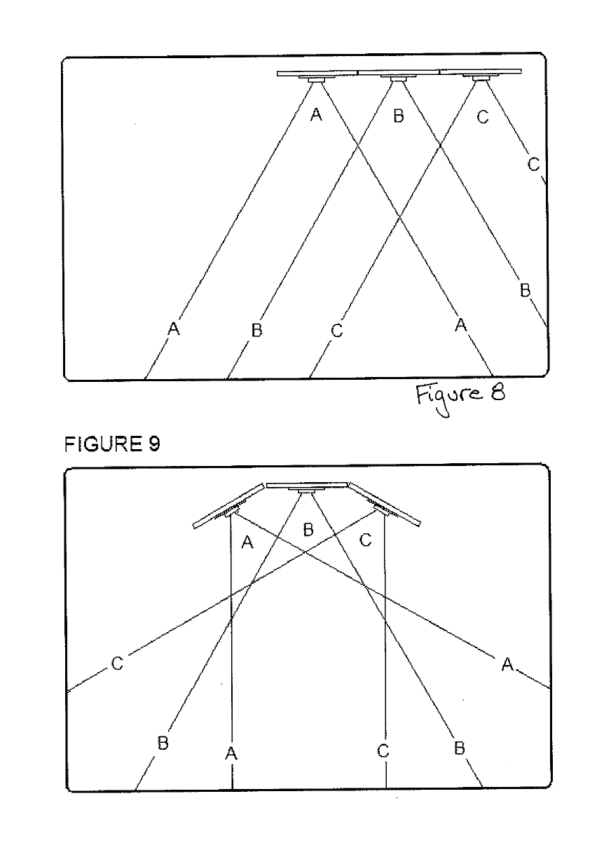

FIG. 8 illustrates an LED lamp configuration where the LEDs are arranged flat against the rear surface of the lamp housing. Each LED projects light at 90 degrees relative to the rear surface of the lamp. The configuration of FIG. 9 provides a wider and improved area of illumination.

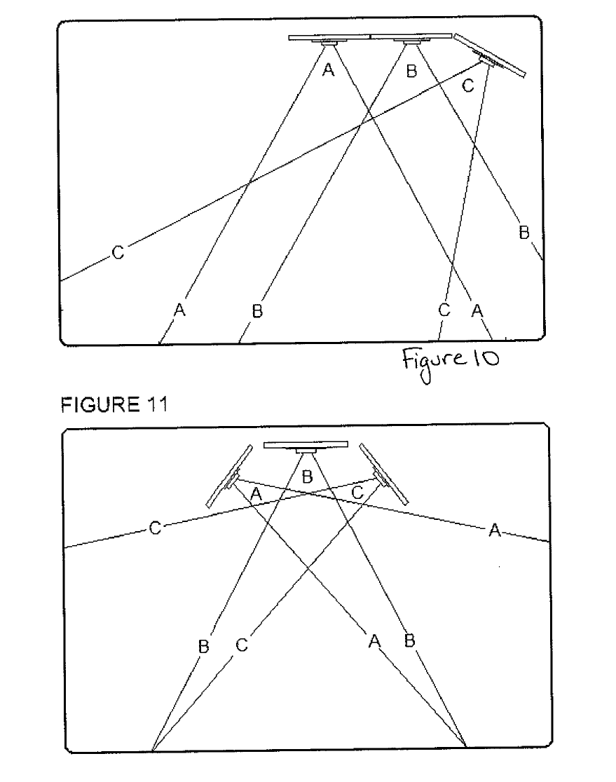

The outer segments 52, 53 are designed to be adjusted by means of a screw or ratchet, to allow for a broad range of angles to be selected. At one extreme the three segments are fully horizontal as in FIG. 8, thus directing all of the LEDs maximum energy at the face of the diffuser lens adjacent to the rear surface of the lamp. At the other extreme both outer segments would be at a high angle as in FIG. 11, thus directing the rows of LED beams to cross and strike the diffuser at the opposite side of the housing to give the maximum diffusion and even dispersion of light in the area around the lamp.

If desired, segments of LEDs can be trained toward one side or the other of the lamp to give more intense illumination in that area outside the lamp as in FIG. 10. For example if the lamp is mounted at the junction of a wall and ceiling the light output could be directed away from the wall, so as to give fuller illumination within a room or enclosed area, as shown in FIG. 10.

A light assembly is shown in the figures for generating light. The light assembly includes a housing and a light support positioned within the housing. The light support includes a center strip segment, a first inclined strip segment, and a second inclined strip segment. The light assembly also includes a series of LEDs positioned along the center strip segment as well as the first and second inclined strip segments. The light assembly further includes a light diffuser positioned over the LEDs to diffuse light generated by the LEDs. The LEDs are positioned along the first and second inclined strip segments at an angle to the LEDs positioned along the center strip segment.

The LEDs of the light assembly are arranged in a linear row along each of the segments so that the light from each of the rows are in the same horizontal plane. The light support can be a monolithic one piece structure. Alternatively, the first and second inclined strip segments can be repositionable with respect to the center strip segment. The light output beams generated by the LEDs positioned along the first and second inclined strip segments overlap with light output beams generated by the LEDs positioned along the center strip segment.

In one embodiment, the first and second inclined strip segments are each coupled to the center strip segment by use of living hinges. The first and second inclined strip segments include a means for retaining their position with respect to the center strip segment. The light support is elongated and generally extends the length of the housing.

While embodiments have been illustrated and described in the drawings and foregoing description, such illustrations and descriptions are considered to be exemplary and not restrictive in character, it being understood that only illustrative embodiments have been shown and described and that all changes and modifications that come within the spirit of the invention are desired to be protected. The applicants have provided description and figures which are intended as illustrations of embodiments of the disclosure, and are not intended to be construed as containing or implying limitation of the disclosure to those embodiments. There are a plurality of advantages of the present disclosure arising from various features set forth in the description. It will be noted that alternative embodiments of the disclosure may not include all of the features described yet still benefit from at least some of the advantages of such features. Those of ordinary skill in the art may readily devise their own implementations of the disclosure and associated methods, without undue experimentation, that incorporate one or more of the features of the disclosure and fall within the spirit and scope of the present disclosure and the appended claims.

1. A light assembly for generating light comprising:
a housing;
a light support positioned within the housing, the light support having a center strip segment, a first inclined strip segment, and a second inclined strip segment;
a series of LEDs positioned along the center strip segment and the first and second inclined strip segments;
a light diffuser positioned over the LEDs to diffuse light generated by the LEDs; and
wherein the LEDs positioned along the first and second inclined strip segments are at an angle to the LEDs positioned along the center strip segment.

2. The light assembly of claim 1, wherein the LEDs are arranged in a linear row along each of the segments so that the light from each of the rows are in the same horizontal plane.

3. The light assembly of claim 1, wherein the light support is a monolithic one piece structure.

4. The light assembly of claim 1, wherein the first and second inclined strip segments are repositionable with respect to the center strip segment.

5. The light assembly of claim 3, wherein the inclined strip segments are positioned with respect to the center strip segment from about zero degrees to about 90 degrees.

6. The light assembly of claim 3, wherein the inclined strip segments are positioned with respect to the center strip segment from about 30 degrees to about 60 degrees.

7. The light assembly of claim 1 wherein light output beams generated by the LEDs positioned along the first and second inclined strip segments overlap with light output beams generated by the LEDs positioned along the center strip segment.

8. The light assembly of claim 4, wherein the first and second inclined strip segments are each coupled to the center strip segment by use of living hinges.

9. The light assembly of claim 8, wherein the first and second inclined strip segments include a means for retaining their position with respect to the center strip segment.

10. The light assembly of claim 1, wherein the housing is elongated.

11. The light assembly of claim 10, wherein the light support is elongated and generally extends the length of the housing.

12. A light assembly for generating light comprising:
a housing;
a light support positioned within the housing, the light support having a center strip segment, a first inclined strip segment, and a second inclined strip segment, wherein the first and second inclined strip segments are repositionable with respect to the center strip segment;
a series of LEDs positioned along the center strip segment and the first and second inclined strip segments;
a light diffuser positioned over the LEDs to diffuse light generated by the LEDs; and
wherein the LEDs positioned along the first and second inclined strip segments are at an angle to the LEDs positioned along the center strip segment.

13. The light assembly of claim 12, wherein the LEDs are arranged in a linear row along each of the segments so that the LEDs in each of the respective rows are in the same horizontal plane.

14. The light assembly of claim 12, wherein the inclined strip segments are positioned with respect to the center strip segment from about zero degrees to about 90 degrees.

15. The light assembly of claim 12, wherein the inclined strip segments are positioned with respect to the center strip segment from about 30 degrees to about 60 degrees.

16. The light assembly of claim 12, wherein light output beams generated by the LEDs positioned along the first and second inclined strip segments overlap with light output beams generated by the LEDs positioned along the center strip segment.

17. The light assembly of claim 12, wherein the first and second inclined strip segments are each coupled to the center strip segment by use of living hinges.

18. The light assembly of claim 17, wherein the first and second inclined strip segments include a means for retaining their position with respect to the center strip segment.

19. The light assembly of claim 12, wherein the housing is elongated.

20. The light assembly of claim 12, wherein the light support is elongated and generally extends the length of the housing.
